(19) United States
(12) Patent Application Publication
(10) Pub. No.: US 2023/0171587 A1
(43) Pub. Date: Jun. 1, 2023

(54) IMEI RETRIEVAL AND IMEI CHANGE NOTIFICATION IN 5GC-EPC INTERWORKING SCENARIOS

(71) Applicant: Telefonaktiebolaget LM Ericsson (PUBL), Stockholm (SE)

(72) Inventors: Emiliano MERINO VAZQUEZ, Madrid (ES); Beatriz MAROTO GIL, Madrid (ES); David CASTELLANOS ZAMORA, MADRID (ES); Jesus Angel DE GREGORIO RODRIGUEZ, Madrid (ES)

(21) Appl. No.: 17/792,077

(22) PCT Filed: Jan. 29, 2021
(86) PCT No.: PCT/EP2021/052206

§ 371 Date: Jul. 11, 2022

(30) Foreign Application Priority Data
Feb. 13, 2020 (EP) 20382100.4

(51) Int. Cl. H04W 8/20

(52) U.S. Cl. CPC H04W 8/20

(57) ABSTRACT

According to an aspect, there is provided a method of operating a first network node (420; 430; 520; 530; 620; 630; 730; 740) in a first core network of a telecommunication network. The first network node (420; 430; 520; 530; 620; 630; 730; 740) is for managing data relating to subscribers of the first core network, and the telecommunication network further comprises a second core network having a second network node (420; 430; 520; 530; 620; 630; 730; 740) that is for managing data relating to subscribers of the second core network. The method comprises, after a first wireless device identifier for a first subscriber of the first core network and the second core network is changed to a second wireless device identifier, sending (1101) a first message to the second the second wireless device identifier for the first subscriber.

### TECHNICAL FIELD

This disclosure relates to the field of telecommunication networks, and in particular to interworking between two core networks in a telecommunication network in relation to changes in a wireless device identifier such as an IMEI in one of those core networks.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Exposure Framework in EPC and 5GC—Cellular Internet of Things (CIoT) is a technology which involves Machine-Type Communication devices (MTC devices) so that a telecommunication network operator may provide other parties/companies access to their network for different applications.

One example of such applications is the use of smart-metering readers, in which an MTC device can be placed in different locations and start sending and receiving data on a regular basis (e.g. electricity consumption reports, water-levels). A vehicle hire company is another example, where an MTC device can be placed in each vehicle to track the consumers/customers, and send them local advertising whenever they pass through a certain location.

An Exposure Function (EF) is a functional entity (i.e. a network function) in a network that receives configurations of different monitoring events (e.g. when a MTC device becomes reachable) initiated by an Application Function (AF), and sends the monitoring events on to a mobility management node in the core network. For a 4^{th} Generation (4G) network the EF is known as a Service Capabilities Exposure Function (SCEF), the mobility management node is a Mobility Management Entity (MME), and the monitoring events are sent from the SCEF to the MME via a Home Subscriber Server (HSS) using the Diameter protocol (the s6t interface, as described in 3GPP TS 29.336, v16.1.0). For a 5^{th} Generation (5G) network the EF is known as a Network Exposure Function (NEF), the mobility management node is an Access and Mobility Management Function (AMF), and the monitoring events are sent from the NEF to the AMF via a Unified Data Management (UDM) node as described in 3GPP TS 29.503 v16.2.0. For some types of monitoring event (e.g. International Mobile Equipment Identifier (IMEI) change) it is possible to detect these locally at the HSS or UDM, and need not be progressed to the serving node for the relevant MTC device.

Depending on the vendor, for a telecommunication network that supports both 4G and 5G, the SCEF and NEF can be implemented as a combined node or as separate nodes. The present disclosure relates to the SCEF and NEF being implemented as a combined node, each handling the monitoring events for their respective types of access network. Also depending on the vendor, the HSS and UDM can also be co-located/combined or deployed as separate functional entities. This is depicted in 3GPP TS 23.501 v16.3.0, clause 5.17.5. The interactions between UDM and HSS when they are deployed in separate functional entities are described in 3GPP TS 23.632 v16.0.0.

Two scenarios have been identified that can cause issues for a combined EF (i.e. a combined SCEF and NEF) when a unique User Equipment (UE) identifier changes. As used in this disclosure, a unique UE identifier can be an IMEI, an IMEI software version (SV), a Permanent Equipment Identifier (PEI), or any other type of wireless device identifier. The first scenario relates to IMEI retrieval. IP Multimedia Subsystem (IMS) defines the possibility for an IMS Application Server (IMS-AS) to fetch (retrieve) the IMEI of a given user from the HSS via Sh reference point as defined in 3GPP TS 29.328 v15.8.0. This IMEI retrieval is also referred to in this disclosure as “Sh IMEI Pull”.

The current state of 3GPP TS 23.632 v16.0.0 does not define a means for the HSS-IMS to be able to retrieve the IMEI for a given UE from the UDM upon request of an IMS-AS over Sh in scenarios where the HSS and the UDM are deployed in separate network functions. Furthermore, this specification does not indicate which IMEI is to be provided to the IMS-AS in case the IMEI stored at the HSS and UDM are different.

As a consequence, the HSS-IMS would be only able to provide the IMS-AS with the IMEI locally available at the HSS (i.e. the IMEI reported to the HSS-Evolved Packet Core (EPC) via EPC access). This may cause wrong decisions at the IMS-AS, as shown in FIG. 1. FIG. 1 is a signalling diagram showing an HSS 110 and UDM 120. At step 100 the HSS 110 has an IMEI associated with a particular subscriber, i.e. IMEI #1 for a subscriber having an International Mobile Subscriber Identity (IMSI). Also at step 100 the UDM 120 has a different IMEI (IMEI #2) associated with the same subscriber (who in 5G is identified by a Subscriber Permanent Identifier (SUPI)).

At step 101 the HSS 110 receives a Sh Pull Req from an IMS-AS. The pull request may indicate the subscriber that it relates to, i.e. the pull request can include the subscriber's IMSI, a Mobile Station International

Subscriber Directory Number (MSISDN) and/or any known IMEI. At step 102 the HSS 110 checks for a stored IMEI relating to the subject of the pull request (i.e. IMEI #1). No interaction is defined between the HSS 110 and the UDM 120 relating to an IMEI registered in a 5G Core (5GC), and so the HSS 110 is not able to obtain IMEI #2 from the UDM 120. In step 103 the HSS 110 responds to the pull request with a Sh Pull Resp including the IMEI for the relevant subscriber (i.e. IMEI #1). The IMS-AS now has an IMEI for the subscriber, but it is not aware that the subscriber has IMEI #2 in the SGC, and so the IMS-AS may take the wrong decision in respect of the subscriber (step 104).

Regarding the second scenario that can cause issues, according to current 3GPP TSs, where HSS and UDM are deployed in separate functional entities—even if the SCEF and NEF are a combined EF—if the IMEI change event is required to be reported to the combined EF for both domains (the 4G-Evolved Packet System (EPS) domain and the 5GC domain), a subscription for IMEI change event detection must be sent to both the HSS and the UDM to ensure that no matter where the UE/MTC device is camping on (4G-EPS or 5GC), the IMEI change event will be detected and reported.

On one hand this is not efficient from a network perspective, since two parallel subscriptions need to be maintained at every moment in the combined EF: one subscription sent via diameter to the HSS, and the other subscription sent via Hyper-Text Transfer Protocol (HTTP) towards the UDM.

On the other hand, this will also cause double notifications to the combined EF: one from the HSS when the UE connects with a new IMEI in EPC (e.g. notification of change from an IMEI #1 to an IMEI #2) and another one from the UDM when the UE connects with the new IMEI #2 in the 5GC. Alternatively, if the UE connects to 5GC using yet another IMEI, e.g. IMEI #3 instead of IMEI #2, the second of these notifications may not be considered duplicated but can be considered as incorrect/erroneous (the old IMEI, if reported, will not be the latest the subscriber was using, i.e. IMEI #2, but it will be IMEI #1 instead). In either case, the duplicated/wrong notifications may eventually cause wrong system decisions to be taken depending on the use of such notifications. This problem is shown in FIG. 2.

FIG. 2 is a signalling diagram showing an HSS 210, a UDM 220 and a combined EF 230. At step 200 the HSS 210 has an IMEI associated with a particular subscriber, i.e. IMEI #1 for a subscriber having an IMSI. Also at step 200 the UDM 120 has the same IMEI (IMEI #1) associated with that subscriber (SUR). In step 201a, the combined EF 230 subscribes to changes in the IMEI for the subscriber at HSS 210 (message S6t Subscribe). In step 201b, the combined EF 230 subscribes to changes in the IMEI for the subscriber at UDM 220 (message Nudm_EE_Subs).

At step 202, the UDM 220 is notified of a change in the IMSI for the subscriber to IMEI #2 (e.g. by message Nudm_UECM_Reg which can occur when the subscriber registers to the 5GC), and at step 203 the UDM 220 updates the IMEI for the subscriber to IMEI #2.

At step 204, as a result of the subscription established in step 201b, the UDM 220 notifies the combined EF 230 of the new IMSI. This can be a Nudm_EE_Notify message, that indicates the old IMEI (IMEI #1), the new IMEI (IMEI #2) and the subscribers identity (SUR). At step 205, the combined EF 230 can now take any appropriate action.

Subsequently, in step 206, the HSS 210 is notified of a change in the IMSI for the subscriber from IMEI #1. This can occur when the subscriber registers to the 4G-EPS, via S6a Update Location Request (ULR)/Update Location Answer (ULA) messages. This may indicate the IMEI for the subscriber as the same already notified to the UDM 220 (i.e. IMEI #2), or a different IMEI, e.g. IMEI #3.

At step 207, as a result of the subscription established in step 201a, the HSS 210 notifies the combined EF 230 of the new IMSI. This can be a S6t Notify message, that indicates the old IMEI (IMEI #1), the new IMEI (IMEI #2 or IMEI #3 as appropriate) and the subscriber's identity (IMSI). At step 208, the combined EF 230 has now received a duplicated notification (if IMEI #2 was signalled in step 207) or a conflicting notification (if IMEI #3 was signalled in step 207), and may take an inappropriate action.

Certain aspects of the present disclosure and their embodiments may provide solutions to these or other challenges.

### SUMMARY

In embodiments of the present disclosure, a HSS and a UDM inform each other about IMEI (wireless device identifier) change events so the latest IMEI (wireless device identifier) used by each UE/subscriber is synchronised in both domains (i.e. 4G and 5G). In other words, various embodiments make the IMEI or other wireless device identifier (containing the smartphone/user equipment/device equipment identity) unique across domains, which reflects the reality of such identifiers. Thus, no matter where the UE is camping on (4G/5G), there should be a single identity all the time. This solution allows for the notification of IMEI change exposure events to be executed just one time from any of the domains. Similarly, retrieval of an IMEI by an IMS-AS over Sh could be supported locally within a HSS without the need for additional interworking with the UDM, since both the UDM and the HSS will be fully aware that the information they have stored is up to date (i.e. an IMEI is unique for each user/subscriber regardless of the domains accessed by each user/subscriber).

Alternative solutions are also provided in which IMEI retrieval is based on a query to HSS/UDM and comparing timestamps.

There are, proposed herein, various aspects and/or embodiments which address one or more of the issues disclosed herein.

According to a first aspect, there is provided a method of operating a first network node in a first core network of a telecommunication network. The first network node is for managing data relating to subscribers of the first core network, and the telecommunication network further comprises a second core network having a second network node that is for managing data relating to subscribers of the second core network. The method comprises, after a first wireless device identifier for a first subscriber of the first core network and the second core network is changed to a second wireless device identifier, sending a first message to the second network node indicating the second wireless device identifier for the first subscriber.

According to a second aspect, there is provided a method of operating a second network node in a second core network of a telecommunication network. The second network node is for managing data relating to subscribers of the second core network, and the telecommunication network further comprises a first core network having a first network node that is for managing data relating to subscribers of the first core network. The data comprises a first wireless device identifier for a first subscriber. The method comprises: receiving a first message from the first network node indicating a second wireless device identifier for the first subscriber; and storing the second wireless device identifier for the first subscriber.

According to a third aspect, there is provided a method of operating an exposure function, EF, node in a telecommunication network. The telecommunication network comprises a first core network comprising a first network node that is for managing data relating to subscribers of the first core network, and a second core network having a second network node that is for managing data relating to subscribers of the second core network. The method comprises: sending a subscription request to only one of the first network node and the second network node, wherein the subscription request requests notification of changes to a wireless device identifier for a first subscriber of the first core network and the second core network.

According to a fourth aspect, there is provided a computer program product comprising a computer readable medium having computer readable code embodied therein. The computer readable code is configured such that, on execution by a suitable computer or processing unit, the computer or processing unit is caused to perform the method according to the first aspect, the second aspect, the third aspect, or any embodiments thereof. According to a fifth aspect, there is provided a first network node for use in a first core network of a telecommunication network. The first network node is for managing data relating to subscribers of the first core network. The telecommunication network further comprises a second core network having a second network node that is for managing data relating to subscribers of the second core network. The first network node is configured to, after a first wireless device identifier for a first subscriber of the first core network and the second core network is changed to a second wireless device identifier, send a first message to the second network node indicating the second wireless device identifier for the first subscriber.

According to a sixth aspect, there is provided a second network node for use in a second core network of a telecommunication network. The second network node is for managing data relating to subscribers of the second core network. The telecommunication network further comprises a first core network having a first network node that is for managing data relating to subscribers of the first core network. The data comprises a first wireless device identifier for a first subscriber. The second network node is configured to receive a first message from the first network node indicating a second wireless device identifier for the first subscriber; and store the second wireless device identifier for the first subscriber.

According to a seventh aspect, there is provided an exposure function, EF, node for use in a telecommunication network. The telecommunication network comprises a first core network comprising a first network node that is for managing data relating to subscribers of the first core network, and a second core network having a second network node that is for managing data relating to subscribers of the second core network. The EF node is configured to: send a subscription request to only one of the first network node and the second network node, wherein the subscription request requests notification of changes to a wireless device identifier for a first subscriber of the first core network and the second core network.

According to an eighth aspect, there is provided a first network node for use in a first core network of a telecommunication network. The first network node is for managing data relating to subscribers of the first core network, and the telecommunication network further comprises a second core network having a second network node that is for managing data relating to subscribers of the second core network. The first network node comprises processing circuitry and a memory, the memory containing instructions executable by said processing circuitry whereby said first network node is operative to, after a first wireless device identifier for a first subscriber of the first core network and the second core network is changed to a second wireless device identifier, send a first message to the second network node indicating the second wireless device identifier for the first subscriber.

According to a ninth aspect, there is provided a second network node for use in a second core network of a telecommunication network. The second network node is for managing data relating to subscribers of the second core network. The telecommunication network further comprises a first core network having a first network node that is for managing data relating to subscribers of the first core network. The data comprises a first wireless device identifier for a first subscriber. The second network node comprises processing circuitry and a memory, the memory containing instructions executable by said processing circuitry whereby said second network node is operative to receive a first message from the first network node indicating a second wireless device identifier for the first subscriber; and store the second wireless device identifier for the first subscriber.

According to a tenth aspect, there is provided an exposure function, EF, node for use in a telecommunication network. The telecommunication network comprises a first core network comprising a first network node that is for managing data relating to subscribers of the first core network, and a second core network having a second network node that is for managing data relating to subscribers of the second core network. The EF node comprises processing circuitry and a memory, the memory containing instructions executable by said processing circuitry whereby said EF node is operative to: send a subscription request to only one of the first network node and the second network node, wherein the subscription request requests notification of changes to a wireless device identifier for a first subscriber of the first core network and the second core network.

Other aspects are also described herein. Certain embodiments or aspects may provide one or more of the following technical advantage(s). One advantage is that a wireless device identifier is unique in the network, no matter the deployment (i.e. 4G/5G). Embodiments propose a smooth way to realise the retrieval of IMEI and notification of IMEI changes to a combined SCEF+NEF in scenarios with EPC and 5GC interworking, by just keeping the IMEIs synchronised and up to date in the two domains. This provides that decisions based on the current stored IMEI and/or on received IMEI change notifications can be accurate.

Finally, by having the IMEI proactively synchronised in the two domains, these embodiments avoid frequent interworking between the UDM and HSS when the IMEI is requested to agree/compare on the last IMEI known across all domains (4G, 5GC).

### BRIEF DESCRIPTION OF THE DRAWINGS

Some of the embodiments contemplated herein will now be described more fully with reference to the accompanying drawings, in which:

FIG. 1 is a signalling diagram illustrating conventional signalling between a HSS and UDM;

FIG. 2 is another signalling diagram illustrating conventional signalling between a HSS and UDM;

FIG. 3 is a diagram showing direct UDM and HSS interworking in a reference point representation;

FIG. 4 is a signalling diagram showing embodiments relating to IMEI change notification;

FIG. 5 is a signalling diagram showing embodiments relating to IMEI retrieval;

FIG. 6 is a signalling diagram showing alternative embodiments relating to IMEI change notification;

FIG. 7 is another signalling diagram showing embodiments relating to IMEI change notification;

FIG. 8 is a signalling diagram showing further alternative solutions relating to IMEI change notification;

FIG. 9 is a schematic block diagram illustrating a virtualization environment in which functions implemented by some embodiments may be virtualized;

FIG. 10 is a schematic block diagram of an apparatus in a wireless/telecommunication network;

FIG. 11 is a flow chart illustrating an exemplary method of operating a first network node;

FIG. 12 is a flow chart illustrating an exemplary method of operating a second network node;

FIG. 13 is a flow chart illustrating an exemplary method of operating an exposure function;

FIG. 14 is a flow chart illustrating an alternative method of operating a first network node; and

FIG. 15 is a flow chart illustrating an alternative method of operating a second network node.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

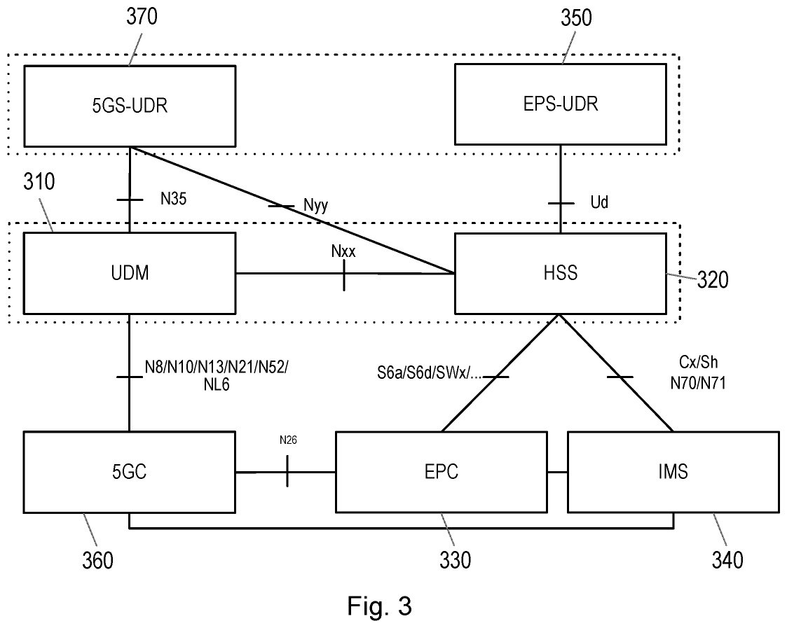

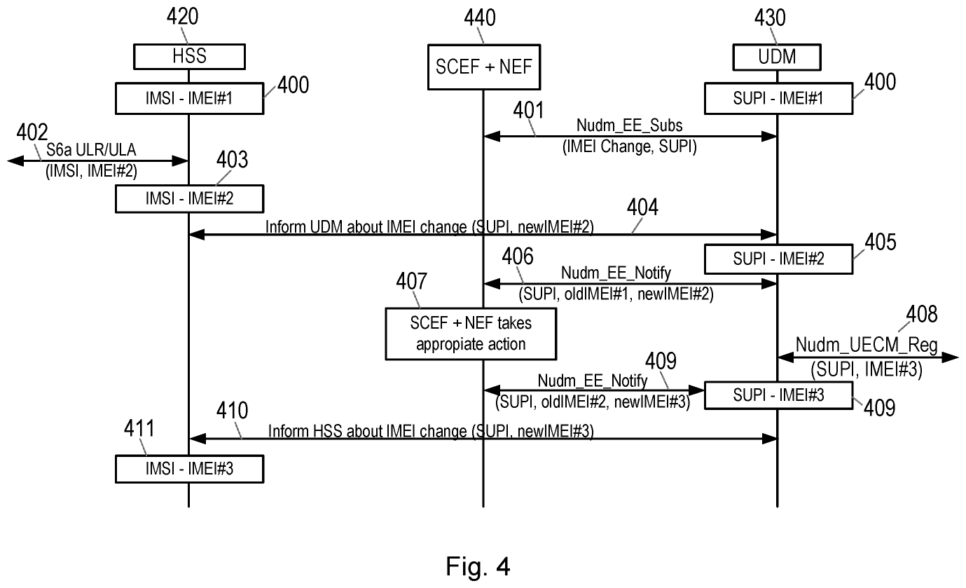

FIG. 3 is a diagram showing direct UDM and HSS interworking in a reference point representation. This figure is found in 3GPP TS 23.632 v6.0.0, FIG. 4.1-2. The HSS 310 and the UDM 320 are connected via an Nxx interface. The HSS 310 is connected to the EPC 330 via various interfaces (S6a/S6d/SWx/ . . . ), connected to an IMS 340 via various interfaces (Cx/Sh/N70/N71) and connected to an EPS Unified Data Repository (EPS-UDR) 350 via a Ud interface. The EPS-UDR 350 stores user data. The UDM 320 is connected to the 5GC 360 via various interfaces (N8/N10/N13/N21/N52/NL6), and connected to a 5G Unified Data Repository (5GS-UDR) 370 via a N35 interface. The 5GS-UDR 370 stores user data. The 5GC 360 is connected to the EPC 330 via an N26 interface, and connected to the IMS 340. The HSS 310 is also connected to the 5GS-UDR 370 via an Nyy interface.

As noted above, in this disclosure the term “wireless device identifier” refers to any type of unique UE identifier, including an IMEI, an IMEI software version (SV), a Permanent Equipment Identifier (PEI). It will be appreciated that although various examples below refer to the wireless device identifier being an IMEI, the examples can also be applied to other types of wireless device identifier.

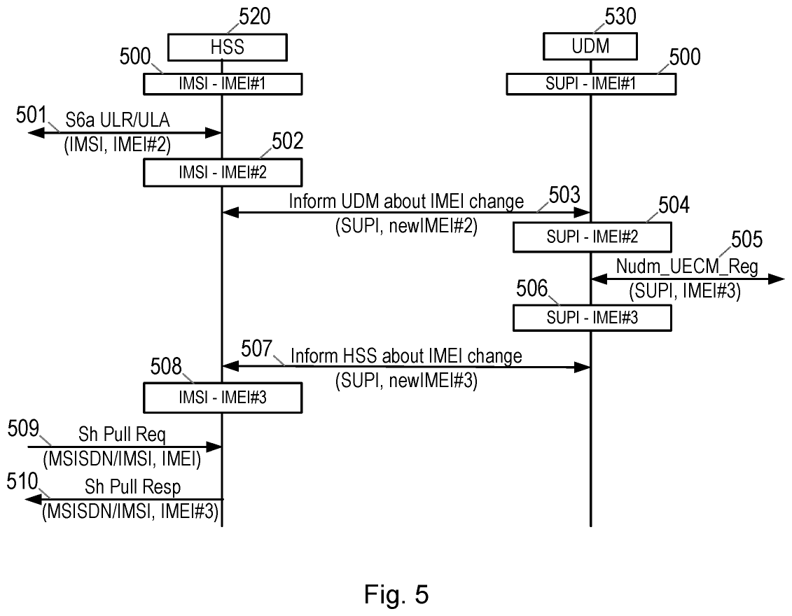

FIG. 4 is a signalling diagram showing embodiments of the provided solutions applied to IMEI change notification. FIG. 5 is a signalling diagram showing embodiments of the provided solutions applied to IMEI retrieval. Both figures show an HSS (420 in FIGS. 4 and 520 in FIG. 5), and a UDM (430 in FIGS. 4 and 530 in FIG. 5). FIG. 4 also shows a combined SCEF and NEF 440.

According to embodiments of the solutions, an aim is to keep the IMEIs for a given UE/subscriber stored in the HSS 420/520 and UDM 430/530 synchronized. That is, when the IMEI(s) for a given UE/subscriber stored in one of the HSS 420/520 and UDM 430/530 changes, the IMEI(s) for that UE/subscriber stored in the other one of the HSS 420/520 and UDM 430/530 should be updated or replaced by the new IMEI(s).

At step 400/500 the HSS 420/520 has an IMEI associated with a particular subscriber, i.e. IMEI #1 for a subscriber having an IMSI. Also at step 400/500 the UDM 430/530 has the same IMEI (IMEI #1) associated with that subscriber (SUR).

In step 401, the combined EF 440 subscribes to changes in the IMEI for the subscriber at UDM 430 (message Nudm_EE_Subs), so that the UDM 430 will inform the combined EF 440 about changes to the IMEI.

At step 402/501, the HSS 420/520 is notified of a change in the IMSI for the subscriber from IMEI #1 to IMEI#2. At step 403/502 the HSS 420/520 updates the stored IMEI for the subscriber to IMEI #2. A change in the IMEI can occur when the subscriber registers to the 4G-EPS, via S6a Update Location Request (ULR)/Update Location Answer (ULA) messages.

After the HSS 420/520 is informed of the IMEI change, the solutions provide that the HSS 420/520 informs the UDM 430/530 about the IMEI change. This is shown by steps 404 and 503. The UDM 430/530 stores the new IMEI (IMEI #2) for the subscriber SUPI (step 405/504). Thus, the new IMEI is synchronized between the HSS 420/520 and the UDM 430/530.

In step 406, the UDM 430 notifies the combined EF 440 of the new IMSI. This can be a Nudm_EE_Notify message, that indicates the old IMEI (IMEI #1), the new IMEI (IMEI #2) and the subscribers identity (SUR). At step 407, the combined EF 230 can now take any appropriate action.

Steps 408-411 and 507-510 show the corresponding operations when the HSS 420 is the node that is first notified of an IMEI change (e.g. to IMEI #3). This notification is in step 408/507, and can be via, e.g., a Nudm_UECM_Reg message which can occur when the subscriber registers to the 5GC. The UDM 430/530 informs the HSS 420/520 about the IMEI change (step 410/507) which stores the new IMEI accordingly (step 411/508).

These solutions allow for the combined SCEF+NEF 440 to subscribe only to one of the domains in order to receive IMEI change notifications. When the IMEI change event occurs in either of the domains, the combined SCEF+NEF 440 is only notified once from the domain where the subscription was made, regardless of the domain where the IMEI change event took place. Thus, if the combined SCEF+NEF 440 subscribes to receive IMEI change event notifications from e.g. the UDM 430 as in step 401, the corresponding notifications are always sent by the UDM 430 regardless of whether the IMEI change event took place in the EPC (steps 402-406) or in the 5GC (steps 408-409).

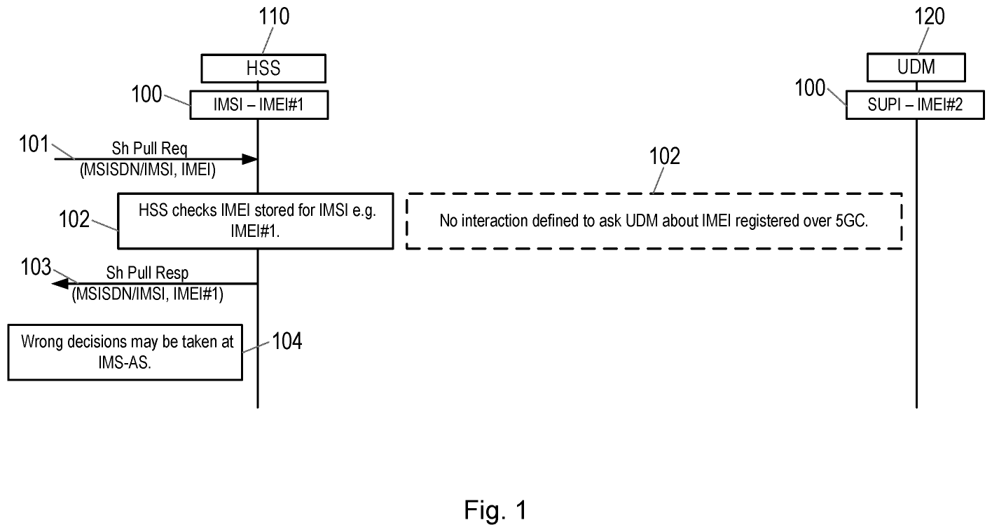

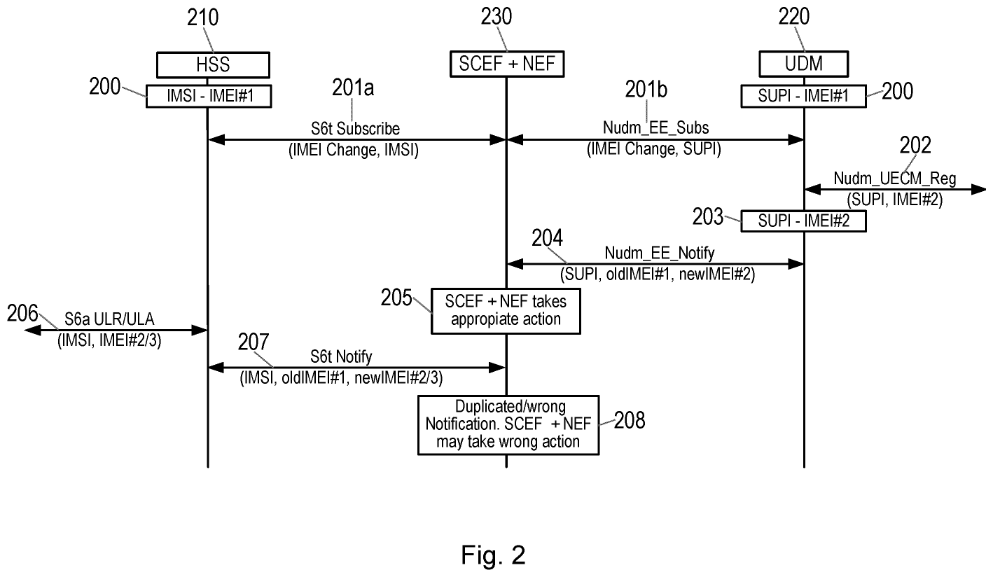

Additionally, these solutions allow that the retrieval of the IMEI for a given UE requested by an IMS-AS from the HSS 520 via Sh can be executed locally by the HSS 520 without the need for additional interworking between the HSS 520 and the UDM 530. This is shown by steps 409-410, which generally correspond to steps 101 and 103 of FIG. 1. The local execution of the retrieval request is useful as retrieval requests may be made on a per voice call basis (e.g. to include the I MEI in charging data records associated to voice calls) and the frequency for the signalling required for interworking between the HSS and UDM if the IMEI is not synchronized would be much higher than the frequency of IMEI changes.

As noted, an aim is to keep the IMEIs for a given UE/subscriber stored in the HSS and the UDM synchronized. This requires interaction between the HSS and the UDM when an IMEI change event is detected in any of the domains as shown in FIGS. 4 and 5. This interaction corresponds to steps 404 and 410 in FIG. 4, and steps 503 and 507 in FIG. 5. Some exemplary services that could be used for this interaction/purpose are set out below:
IMEI change events are normally detected in a HSS and/or a UDM during initial attach/registration procedures. 3GPP TS 23.632 v16.0.0 defines that at initial attach in EPC, the HSS informs the UDM to delete the registration of the UE in the AMF (if any) via a Nudm_UECM_AMFDeregistration service operation. Similarly, the UDM informs the HSS to delete the registration of the UE in the MME (if any) via a Nhss_UECM_MMEDeregistration service operation. In the present solutions, when an IMEI change event is detected during an initial attach/registration procedure, the HSS and UDM can include the new IMEI in the request to remove the UE registration from the other domain. This is the new IMEI, and can be defined as an optional parameter in Nudm_UECM_AMFDeregistration and Nhss_UECM_MMEDeregistration service operations.
It is possible that the IMEI can be changed while the UE is registered in any of the domains. For example, this can occur if the UE is updated with a new software version. Also, Nudm_UECM_AMFDeregistration and Nhss_UECM_MMEDeregistration services are not used when the system works in dual registration mode or without N26. For these cases, the new IMEI can be conveyed as follows:
from the HSS to the UDM using the existing Nudm_UECM_Update service operation; and
from the UDM to the HSS using a new Nhss_UECM_Update service operation.

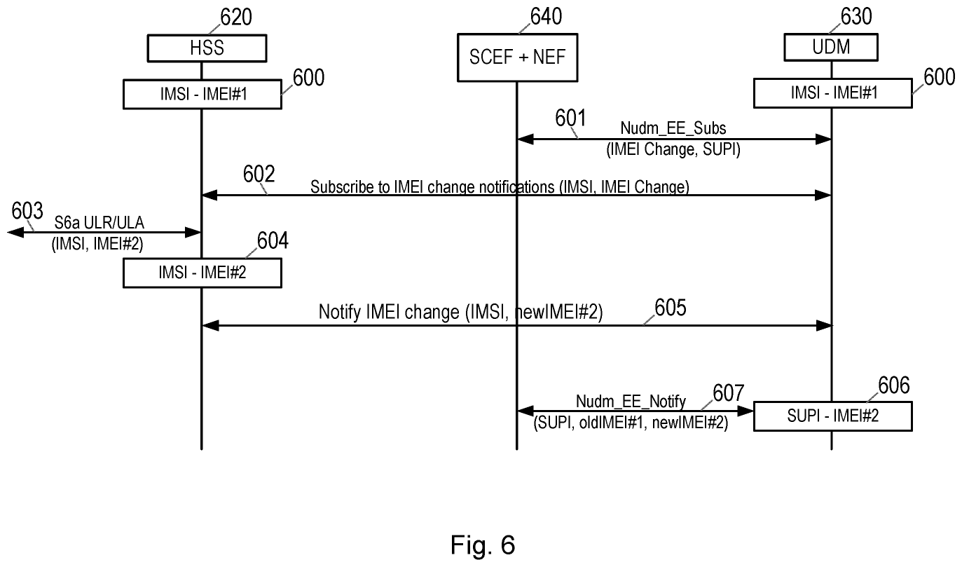

In the embodiments of the solutions shown in FIGS. 4 and 5, the HSS 420/520 and UDM 430/530 are already configured to notify the other in the event of an IMEI change. FIG. 6 shows an alternative embodiment in which one of the HSS and UDM subscribes to changes in IMEI from the other one of the HSS and UDM 430/530, although it will be appreciated that in practice both the HSS and the UDM may need to subscribe to changes in IMEI from the other node. FIG. 6 relates to the IMEI change notification to a combined EF scenario (e.g. as shown in FIG. 4), but it will be appreciated that similar principles can be applied to the IMEI retrieval scenario in FIG. 5.

Thus, FIG. 6 shows an HSS 620, a UDM 630 and a combined SCEF and NEF 640. Steps 600 and 601 generally correspond to steps 400 and 401. In step 602, the UDM 630 subscribes to IMEI change notifications from the HSS 620 for the subscriber.

The HSS 620 is then informed of an IMEI change (steps 603 and 604, which generally correspond to steps 402 and 403) and the HSS 620 notifies the UDM 630 of the IMEI change in step 605. The UDM 630 stores the updated IMEI (step 606, generally corresponding to step 405) and notifies the combined EF 640 (step 607, generally corresponding to step 406).

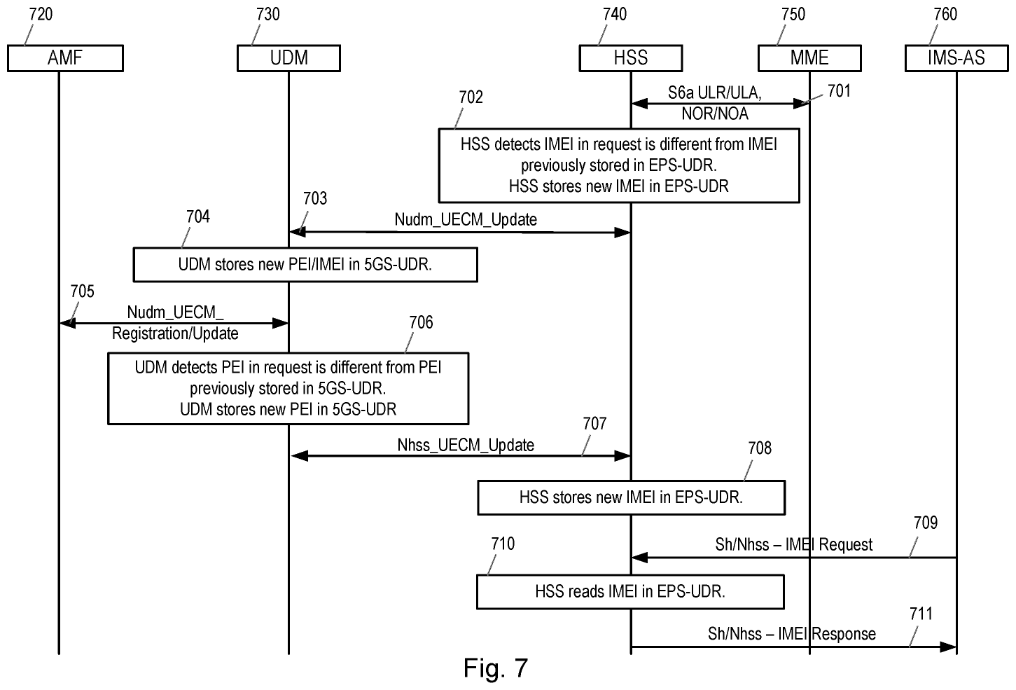

FIG. 7 is a signalling diagram that can be included in 3GPP TS 23.632 to capture the solutions provided herein. As noted above, it is proposed that the HSS and UDM inform each other about IMEI change events so the latest IMEI used by each UE is always synchronized in both domains. This allows for the retrieval of IMEI by an IMS-AS over Sh to be supported locally within the HSS without the need of additional interworking with the UDM, since both UDM and HSS are fully aware that the information they have stored is up to date (i.e. the IMEI is unique for each user regardless of the domains accessed by each user). This approach is considered to be more effective over other alternatives (e.g. HSS asking UDM for the IMEI stored for the UE in 5GC at every Sh request) since the number of requests from ASs to fetch the IMEI is foreseen to occur very frequently, whereas the users do not change their smart phone (i.e. their IMEI) very often.

A pre-requisite for the retrieval of the IMEI when requested by an IMS-AS is that the IMEI for a given UE stored in HSS and UDM is always synchronized. That is, when the HSS detects that the IMEI for a UE changes (e.g. during an Update Location in EPS), the HSS informs the UDM about the IMEI change which stores the new IMEI accordingly. Similarly, when UDM detects that the IMEI changes, the UDM informs the HSS about the IMEI change which stores the new IMEI accordingly. This allows for the retrieval of the IMEI for a given UE requested by an IMS-AS from HSS via Sh to be executed locally by HSS without the need of additional interworking between the HSS and the UDM.

FIG. 7 shows signalling between an AMF 720, a UDM 730, a HSS 740, a MME 750 and an IMS-AS 760. FIG. 7 shows the scenario where the HSS 740 receives an IMEI retrieval request from the IMS-AS 760 for a subscriber who has a 5GC subscription. Steps 701 to 704 are executed when the HSS 740 detects a change in the IMEI for a given UE (IMSI).

In step 701, the HSS 740 receives a request from the MME 750 including an IMEI for the UE (e.g. Update Location Request or Notify Request).

In step 702, the HSS 740 detects that the IMEI received in the request is different from the previously stored in the EPS-UDR. The HSS 740 stores the new IMEI in the EPS-UDR.

In step 703, the HSS 740 informs the UDM 730 about the new PEI (IMEI) using the Nudm_UECM_Update service operation.

In step 704, the UDM 730 stores the new PEI for the UE.

Steps 705 to 708 are executed when the UDM 730 detects a change in the PEI for a given UE (SUR).

In step 705, the UDM 730 receives a request from the AMF 720 including a PEI for the UE (e.g. Nudm_UECM_Registration/Update).

In step 706, the UDM 730 detects that the PEI received in the request is different from the previously stored in the 5GS-UDR. The UDM 730 stores the new IMEI in the 5GS-UDR.

In step 707, the UDM 730 informs the HSS 740 about the new IMEI using the Nhss_UECM_Update service operation.

In step 708, the HSS 740 stores the new IMEI for the UE.

Steps 709 to 711 are executed when the HSS 740 receives an IMEI retrieval request from the IMS-AS 760 for a subscriber who has a 5GC subscription.

In step 709, the HSS 740 receives a request from IMS-AS 760 to retrieve the IMEI for a UE.

In step 710, the HSS 740 reads the IMEI stored in the EPS-UDR.

In step 711, the HSS 740 replies to the IMS-AS 760 with the users IMEI. Since the IMEI for the UE has been synchronized between HSS 740 and UDM 730 at every IMEI/PEI change event as in steps 701 to 704 or 705 to 708, the HSS 740 can reply to the IMS-AS 760 without any additional interworking with the UDM 730.

Table 6.1.1-1 in 3GPP TS 23.632 that indicates NF services provided by the HSS can be modified to include an update service operation in the UECM NF service, and similarly Table 6.2.1-1 in 3GPP TS 23.632 that indicates NF services provided by the UDM can be modified to include the update service operation in the UECM NF service. The Nhss_UECM_Update service can be defined for an NF consumer to inform the HSS about an update in the UE Context (e.g. a change in the IMEI).

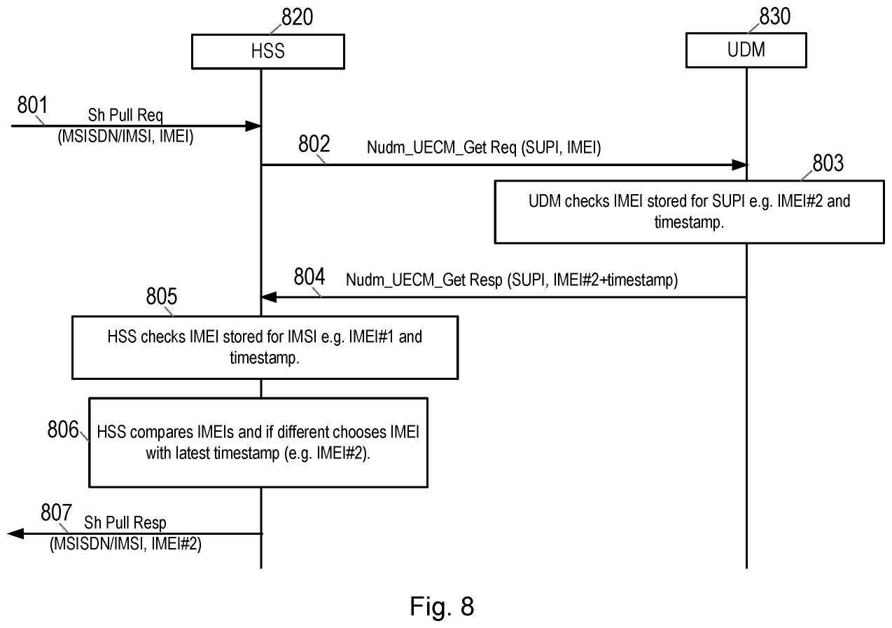

As an alternative to the solutions provided above in which the IMEIs for a given UE/subscriber stored in the HSS and UDM are kept synchronized, some solutions provide that the HSS/UDM can retrieve the IMEI from the other node when an IMS-AS requests the IMEI for the subscriber. This is illustrated in FIG. 8. FIG. 8 shows the signalling between an HSS 820 and a UDM 830. In this solution, it is not assumed that the HSS 820 and UDM 830 keep the IMEIs for a given UE synchronized (i.e. the HSS 820 and UDM 830 may store different versions of the IMEI for a given UE). Therefore, upon reception of a Sh request from the IMS-AS (shown as step 801), the HSS 820 asks the UDM 830 for the IMEI value kept for the UE (step 802). This could be done e.g. using the existing Nudm_UECM_Get service operation but extended to request the IMEI explicitly.

In step 803 the UDM 830 would then retrieve the IMEI stored for the UE together with a timestamp for the IMEI. The timestamp is required to be stored when the IMEI was updated in UDM 830, and indicates the date/time of the update to the IMEI.

The UDM 830 provides the IMEI (e.g. IMEI #2) together with the timestamp to the HSS 820 (step 804). In step 805 the HSS 820 compares the IMEI received from the UDM 830 with the one locally stored. If the IMEIs are different, the HSS 820 then compares the received timestamp to a timestamp associated with the IMEI stored by the HSS 820 to determine the most recent IMEI. The IMEI with the most recent timestamp is selected (step 806). The HSS 820 replies to the IMS AS with the IMEI with the latest timestamp (step 807).

Therefore, with this solution, each time that an AS tries to fetch the current or last known IMEI, the HSS 820 needs to send a request to the UDM 830 for an IMEI and then compare the timestamps. It will be appreciated that this may not be particularly efficient, since the number of requests from ASs to fetch the IMEI is foreseen to occur very frequently, whereas users do not change their smart phone (i.e. their I MEI) very often.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

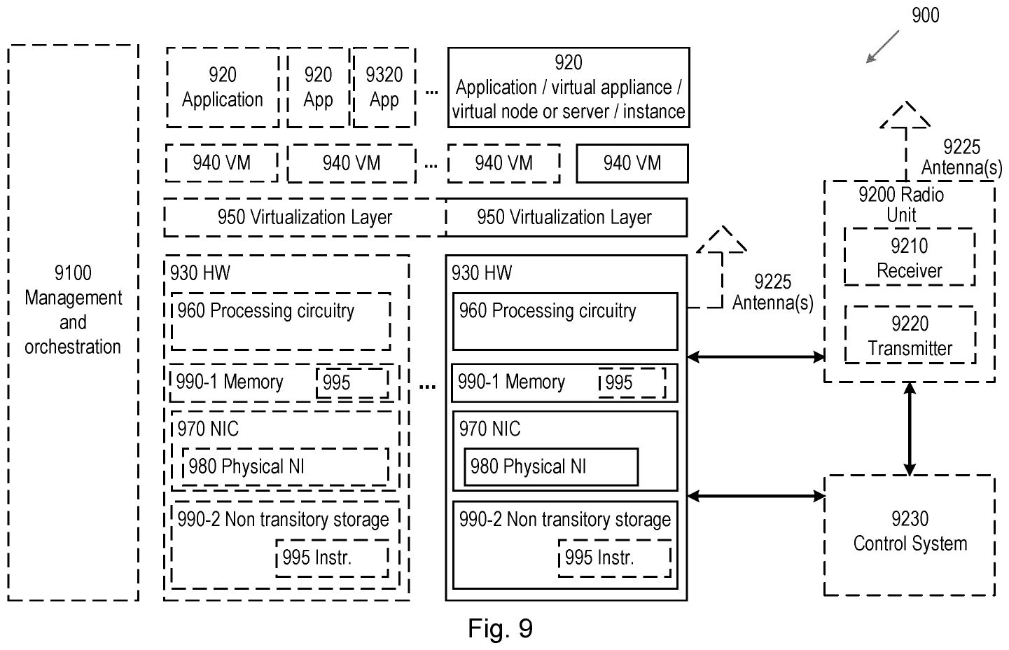

FIG. 9 is a schematic block diagram illustrating a virtualization environment 900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized network node, such as an HSS, a UDM, or combined EF), a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 900 hosted by one or more of hardware nodes 930. Further, in embodiments in which the virtual node is not a radio access node or does not require radio connectivity (e.g., a core network node), then the network node may be entirely virtualized.

The functions may be implemented by one or more applications 920 (which may alternatively be called software instances, virtual appliances, network functions, virtual nodes, virtual network functions, etc.) operative to implement some of the features, functions, and/or benefits of some of the embodiments disclosed herein. Applications 920 are run in virtualization environment 900 which provides hardware 930 comprising processing circuitry 960 and memory 990. Memory 990 contains instructions 995 executable by processing circuitry 960 whereby application 920 is operative to provide one or more of the features, benefits, and/or functions disclosed herein.

Virtualization environment 900, comprises general-purpose or special-purpose network hardware devices 930 comprising a set of one or more processors or processing circuitry 960, which may be commercial off-the-shelf (COTS) processors, dedicated Application Specific Integrated Circuits (ASICs), or any other type of processing circuitry including digital or analog hardware components or special purpose processors. Each hardware device may comprise memory 990-1 which may be non-persistent memory for temporarily storing instructions 995 or software executed by processing circuitry 960. Each hardware device may comprise one or more network interface controllers (NICs) 970, also known as network interface cards, which include physical network interface 980. Each hardware device may also include non-transitory, persistent, machine-readable storage media 990-2 having stored therein software 995 and/or instructions executable by processing circuitry 960. Software 995 may include any type of software including software for instantiating one or more virtualization layers 950 (also referred to as hypervisors), software to execute virtual machines 940 as well as software allowing it to execute functions, features and/or benefits described in relation with some embodiments described herein.

Virtual machines 940, comprise virtual processing, virtual memory, virtual networking or interface and virtual storage, and may be run by a corresponding virtualization layer 950 or hypervisor. Different embodiments of the instance of virtual appliance 920 may be implemented on one or more of virtual machines 940, and the implementations may be made in different ways.

During operation, processing circuitry 960 executes software 995 to instantiate the hypervisor or virtualization layer 950, which may sometimes be referred to as a virtual machine monitor (VMM). Virtualization layer 950 may present a virtual operating platform that appears like networking hardware to virtual machine 940.

As shown in FIG. 9, hardware 930 may be a standalone network node with generic or specific components. Hardware 930 may comprise antenna 9225 and may implement some functions via virtualization. Alternatively, hardware 930 may be part of a larger cluster of hardware (e.g. such as in a data center or customer premise equipment (CPE)) where many hardware nodes work together and are managed via management and orchestration (MANO) 9100, which, among others, oversees lifecycle management of applications 920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 940 may be a software implementation of a physical machine that runs programs as if they were executing on a physical, non-virtualized machine. Each of virtual machines 940, and that part of hardware 930 that executes that virtual machine, be it hardware dedicated to that virtual machine and/or hardware shared by that virtual machine with others of the virtual machines 940, forms a separate virtual network elements (VNE).

Still in the context of NFV, Virtual Network Function (VNF) is responsible for handling specific network functions that run in one or more virtual machines 940 on top of hardware networking infrastructure 930 and corresponds to application 920 in FIG. 9.

In some embodiments, one or more radio units 9200 that each include one or more transmitters 9220 and one or more receivers 9210 may be coupled to one or more antennas 9225. Radio units 9200 may communicate directly with hardware nodes 930 via one or more appropriate network interfaces and may be used in combination with the virtual components to provide a virtual node with radio capabilities, such as a radio access node or a base station.

In some embodiments, some signalling can be effected with the use of control system 9230 which may alternatively be used for communication between the hardware nodes 930 and radio units 9200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

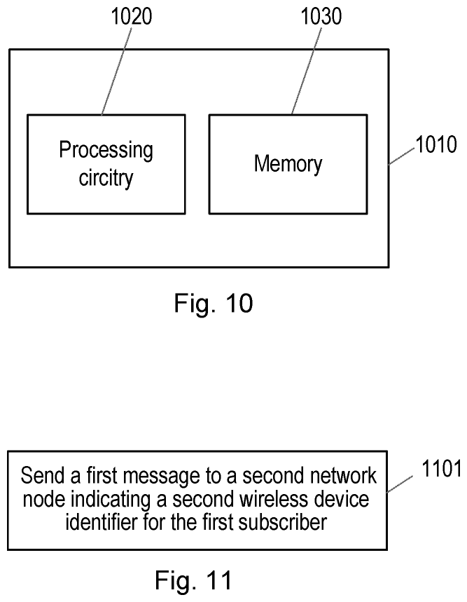

FIG. 10 illustrates a schematic block diagram of an apparatus 1010 in a wireless/telecommunication network or for use in a wireless/telecommunication network. The apparatus may be implemented in a network node (e.g. an HSS 420, 520, 620, 820, a UDM 430, 530, 630, 830), and/or in a combined EF 440, 640. Alternatively, the apparatus may be a network node (e.g. an HSS 420, 520, 620, 820, a UDM 430, 530, 630, 830) or a combined EF 440, 640. Apparatus 1010 is operable to carry out some or all parts of the exemplary methods and processes described herein, for example the exemplary methods and processes described above with reference to FIG. 4, 5, 6, 7 or 8, and/or the exemplary methods and processes described below with reference to FIG. 11, 12, 13, 14 or 15.

Apparatus 1010, which may be a virtual apparatus, may comprise processing circuitry 1020, which may include one or more microprocessor or microcontrollers, as well as other digital hardware, which may include digital signal processors (DSPs), special-purpose digital logic, and the like. The processing circuitry 1020 may be configured to execute program code stored in memory 1030, which may include one or several types of memory such as read-only memory (ROM), random-access memory, cache memory, flash memory devices, optical storage devices, etc. Program code stored in memory 1030 includes program instructions for executing one or more telecommunications and/or data communications protocols as well as instructions for carrying out one or more of the techniques described herein, in several embodiments.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

FIG. 11 is a flow chart illustrating an exemplary method of operating a first network node. The first network node is in a first core network of a telecommunication network. The first network node is for managing data relating to subscribers of the first core network, and the telecommunication network further comprises a second core network having a second network node that is for managing data relating to subscribers of the second core network. In some embodiments, the first network node is a HSS 420/520/620/740, and the second network node is a UDM node 430/530/630/730. In alternative embodiments, the first network node is a UDM node 430/530/630/730 and the second network node is a HSS 420/520/620/740.

In step 1101, the first network node sends a first message to the second network node. The first message is sent to the second network node after a first wireless device identifier for a first subscriber of the first core network and the second core network is changed to a second wireless device identifier. The first message indicates the second wireless device identifier for the first subscriber. In some embodiments, each of the first wireless device identifier and/or the second wireless device identifier are one or more of an IMEI, an IMEI SV, or a PEI.

In some embodiments, the first message indicates that a wireless device identifier for the first subscriber has changed to the second wireless device identifier. In alternative embodiments, the first message indicates that the first wireless device identifier for the first subscriber has changed to the second wireless device identifier.

In some embodiments, the method further comprises the first network node receiving a message from a serving node for the first subscriber. This message can indicate that the wireless device identifier for the first subscriber has changed to the second wireless device identifier. The receipt of this message can trigger or cause the first network node to send the first message in step 1101.

In some embodiments, the method in the first network node can further comprise receiving an identifier request for the wireless device identifier for the first subscriber from a third network node. The first network node can then send the second wireless device identifier for the first subscriber to the third network node. The third network node may be an IMS-AS, for example the IMS-AS 760 shown in FIG. 7.

In some embodiments, the method further comprises receiving a subscription request from an EF node in the telecommunication network. This subscription request can request notification of changes to the wireless device identifier for the first subscriber. Thus, after the change to the second wireless device identifier for the first subscriber, the first network node notifies the EF node of the second wireless device identifier for the first subscriber. The EF node may be a combined SCEF+NEF, for example the combined SCEF+NEF 440/640 shown in FIGS. 4 and 6.

In some embodiments, the first message is a deregistration message that triggers the deletion of a registration of the wireless device for the first subscriber from a mobility management node in the second core network. The mobility management node may be an MME or AMF, for example the MME 750 and/or AMF 720 shown in FIG. 7. The deregistration message may be a Nudm_UECM_AMFDeregistration service operation or a Nhss_U ECM_M ME Deregistration service operation.

Alternatively, the first message can be a registration update message that triggers the update of a registration of the wireless device for the first subscriber in a mobility management node in the second core network. The mobility management node may be an MME or AMF, for example the MME 750 and/or AMF 720 shown in FIG. 7. The registration update message may be a Nudm_UECM_Update service operation or a Nhss_UECM_Update service operation.

In alternative embodiments, for example as shown in FIG. 6, the method in the first network node can further comprise receiving a subscription request from the second network node. This subscription request requests notification of changes to the wireless device identifier for the first subscriber. Thus, if a change to the wireless device identifier occurs at the first network node, the first network node notifies the second network node of the change. In these embodiments, the first message is sent in step 1101 as a result of the subscription request and the change of the wireless device identifier for the first subscriber to the second wireless device identifier.

In some embodiments, for example as shown in FIG. 6, the method in the first network node can further comprise sending a subscription request to the second network node. This subscription request requests notification of changes to the wireless device identifier for the first subscriber from the second network node. Thus, if a change to the wireless device identifier occurs at the second network node, the second network node notifies the first network node of the change. These embodiments can be used independently of, or in combination with, the above embodiments in which the first network node receives a subscription request from the second network node.

In some embodiments, the method in the first network node can further comprise receiving a message from the second network node. This message can indicate a third wireless device identifier for the first subscriber. In that case, the first network node can store the third wireless device identifier for the first subscriber.

In embodiments where the first network node sends a subscription request to the second network node, the third message can be received from the second network node as a result of the third subscription request and a change to the wireless device identifier for the first subscriber.

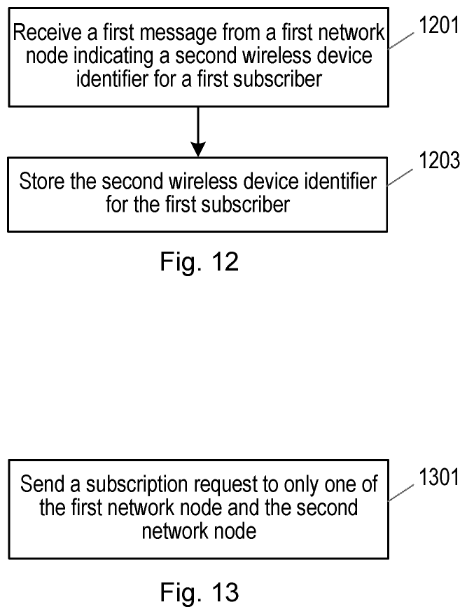

FIG. 12 is a flow chart illustrating an exemplary method of operating a second network node. The second network node is in a second core network of a telecommunication network. The second network node is for managing data relating to subscribers of the second core network, and the telecommunication network further comprises a first core network having a first network node that is for managing data relating to subscribers of the first core network. In some embodiments, the second network node is a HSS 420/520/620/740, and the first network node is a UDM node 430/530/630/730. In alternative embodiments, the second network node is a UDM node 430/530/630/730 and the first network node is a HSS 420/520/620/740.

In step 1201, the second network node receives a first message from the first network node. The first message indicates a second wireless device identifier for the first subscriber. In some embodiments, the second wireless device identifier is one or more of an IMEI, an IMEI SV, or a PEI.

In step 1203, the second network node stores the second wireless device identifier for the first subscriber.

In some embodiments, the first message indicates that a wireless device identifier for the first subscriber has changed to the second wireless device identifier. In alternative embodiments, the first message indicates that the first wireless device identifier for the first subscriber has changed to the second wireless device identifier.

In some embodiments, the method in the second network node can further comprise receiving an identifier request for the wireless device identifier for the first subscriber from a third network node. The second network node can then send the second wireless device identifier for the first subscriber to the third network node. The third network node may be an IMS-AS, for example the IMS-AS 760 shown in FIG. 7.

In some embodiments, the method further comprises receiving a subscription request from an EF node in the telecommunication network. This subscription request can request notification of changes to the wireless device identifier for the first subscriber. Thus, after receiving the first message in step 1201, indicating the second wireless device identifier for the first subscriber, the second network node notifies the EF node of the second wireless device identifier for the first subscriber. The EF node may be a combined SCEF+NEF, for example the combined SCEF+NEF 440/640 shown in FIGS. 4 and 6.

In some embodiments, the method in the second network node can further comprise receiving a message from a serving node for the first subscriber. This message can indicate that the wireless device identifier for the first subscriber has changed to a third wireless device identifier. In these embodiments, the method can further comprise sending a third message to the first network node. The third message can indicate the third wireless device identifier for the first subscriber.

In some embodiments, the first message is a deregistration message that triggers the deletion of a registration of the wireless device for the first subscriber from a mobility management node in the second core network. The mobility management node may be an MME or AMF, for example the MME 750 and/or AMF 720 shown in FIG. 7. The deregistration message may be a Nudm_UECM_AMFDeregistration service operation or a Nhss_UECM_MMEDeregistration service operation.

Alternatively, the first message can be a registration update message that triggers the update of a registration of the wireless device for the first subscriber in a mobility management node in the second core network. The mobility management node may be an MME or AM F, for example the MME 750 and/or AM F 720 shown in FIG. 7. The registration update message may be a Nudm_UECM_Update service operation or a Nhss_UECM_Update service operation.

In alternative embodiments, for example as shown in FIG. 6, the method in the second network node can further comprise (prior to receiving the first message in step 1201) sending a subscription request to the first network node. This subscription request requests notification of changes to the wireless device identifier for the first subscriber. Thus, if a change to the wireless device identifier occurs at the first network node, the first network node notifies the second network node of the change. In these embodiments, the first message is received in step 1201 as a result of this subscription request.

In some embodiments, for example as shown in FIG. 6, the method in the second network node can further comprise receiving a subscription request from the first network node. This subscription request requests notification of changes to the wireless device identifier for the first subscriber from the second network node. Thus, if a change to the wireless device identifier occurs at the second network node, the second network node notifies the first network node of the change. These embodiments can be used independently of, or in combination with, the above embodiments in which the second network node sends a subscription request to the first network node.

FIG. 13 is a flow chart illustrating an exemplary method of operating an exposure function (EF). The EF is in a telecommunication network. The telecommunication network comprises a first core network comprising a first network node that is for managing data relating to subscribers of the first core network, and a second core network having a second network node that is for managing data relating to subscribers of the second core network. The EF may be a combined SCEF and NEF.

In some embodiments, the first network node is a HSS 420/520/620/740, and the second network node is a UDM node 430/530/630/730. In alternative embodiments, the first network node is a UDM node 430/530/630/730 and the second network node is a HSS 420/520/620/740.

In step 1301, the EF sends a subscription request to only one of the first network node and the second network node. The subscription request requests notification of changes to a wireless device identifier for a first subscriber of the first core network and the second core network. Thus, the EF does not send a subscription request to the other one of the first network node and the second network node.

Subsequently, the EF can receive a notification for the first subscriber of a change from a first wireless device identifier to a second wireless device identifier from the one of the first network node and the second network node.

In some embodiments, each of the first wireless device identifier and/or the second wireless device identifier are one or more of an IMEI, an IMEI SV, or a PEI.

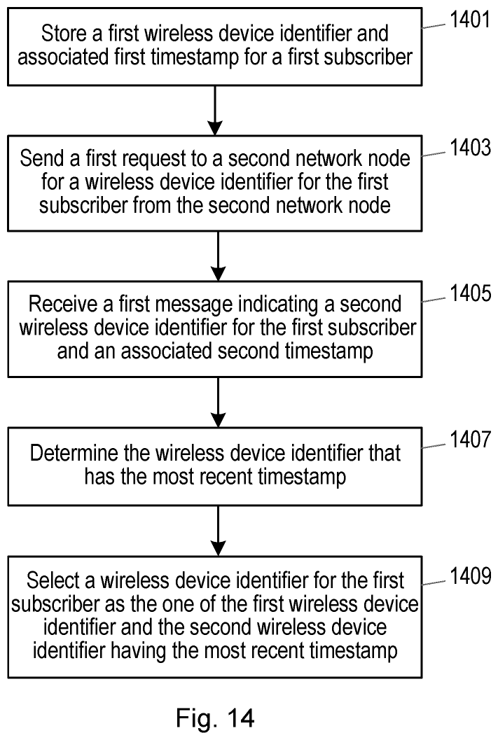

FIG. 14 is a flow chart illustrating an alternative method of operating a first network node. The first network node is in a first core network of a telecommunication network. The first network node is for managing data relating to subscribers of the first core network. In some embodiments, the first network node is a HSS 820, and the second network node is a UDM node 830. In alternative embodiments, the first network node is a UDM node 830 and the second network node is a HSS 820. The method shown in FIG. 14 relates to the technique shown in FIG. 8.

Thus, in step 1401, the first network node stores a first wireless device identifier for a first subscriber. The first network node also stores a first timestamp associated with the first wireless device identifier. The first timestamp indicates the date and/or time that the wireless device identifier of the first subscriber was set/updated to the first wireless device identifier. In some embodiments, the first wireless device identifier is one or more of an IMEI, an IMEI SV, or a PEI.

In step 1403, the first network node sends a first request to a second network node. The second network node is in a second core network of the telecommunication network. The first request sent in step 1403 requests a wireless device identifier for the first subscriber from the second network node. 46. In embodiments where the first network node is a HSS and the second network node is a UDM node, the first request may be a Nudm_UECM_Get service operation.

In step 1405, the first network node receives a first message from the second network node. The first message indicates a second wireless device identifier for the first subscriber and a second timestamp associated with the second wireless device identifier. The second timestamp indicates the date and/or time that the wireless device identifier of the first subscriber was set/updated to the second wireless device identifier. In some embodiments, the second wireless device identifier is one or more of an IMEI, an IMEI SV, or a PEI.

In step 1407, the first network node determines which of the first wireless device identifier and the second wireless device identifier has the most recent timestamp. This step can comprise comparing the respective timestamps for the first wireless device identifier and the second wireless device identifier.

In step 1409, the first network node selects a wireless device identifier for the first subscriber as the one of the first wireless device identifier and the second wireless device identifier having the most recent timestamp.

In some embodiments, the first request is sent to the second network node in step 1403 in response to the first network node receiving a second request from a third network node. The second request requests the wireless device identifier for the first subscriber. The third network node may be an IMS-AS. Thus, in some embodiments, the method by the first network node further comprises receiving the second request for the wireless device identifier for the first subscriber, and sending the selected one of the first wireless device identifier and the second wireless device identifier for the first subscriber to the third network node.

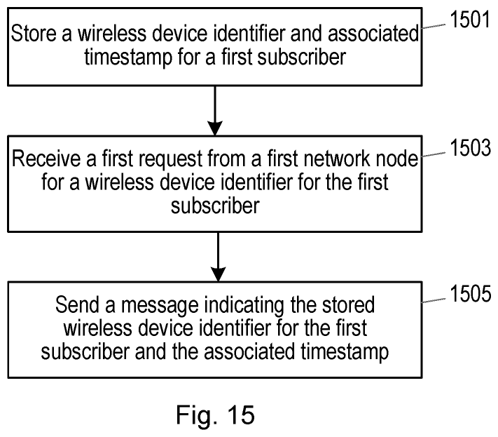

FIG. 15 is a flow chart illustrating an alternative method of operating a second network node. The second network node is in a second core network of a telecommunication network. The second network node is for managing data relating to subscribers of the second core network. In some embodiments, the second network node is a HSS 820, and in other embodiments the second network node is a UDM node 830. The method shown in FIG. 15 relates to the technique shown in FIG. 8.

In step 1501, the second network node stores a wireless device identifier for a first subscriber. The second network node also stores a timestamp associated with the wireless device identifier. The timestamp indicates the date and/or time that the wireless device identifier of the first subscriber was set/updated to the wireless device identifier. In some embodiments, the wireless device identifier is one or more of an IMEI, an IMEI SV, or a PEI.

In step 1503, the second network node receives a first request from a first network node in a first core network of the telecommunication network. The first request requests a wireless device identifier for the first subscriber from the second network node. The first network node may be a HSS 820 or a UDM node 830. In particular embodiments, the first network node is a HSS 820 and the second network node is a UDM node 830. In other particular embodiments, the first network node is a UDM node 830 and the second network node is a HSS 820. In embodiments where the first network node is a HSS 820 and the second network node is a UDM node 830, the first request can be a Nudm_UECM_Get service operation.

In step 1505, the second network node sends a first message to the first network node. The first message indicates the stored wireless device identifier for the first subscriber and the timestamp associated with the stored wireless device identifier.

Various exemplary techniques, embodiments and/or solutions are set out in the following set of numbered statements:
1. A method of operating a first network node in a first core network of a telecommunication network, wherein the first network node is for managing data relating to subscribers of the first core network, wherein the telecommunication network further comprises a second core network having a second network node that is for managing data relating to subscribers of the second core network, wherein the method comprises:
   after a first wireless device identifier for a first subscriber of the first core network and the second core network is changed to a second wireless device identifier, sending a first message to the second network node indicating the second wireless device identifier for the first subscriber.
2. A method as defined in statement 1, wherein the first message indicates that a wireless device identifier for the first subscriber has changed to the second wireless device identifier.
3. A method as defined in statement 1, wherein the first message indicates that the first wireless device identifier for the first subscriber has changed to the second wireless device identifier.
4. A method as defined in any of statements 1-3, wherein the method further comprises:
   receiving a second message from a serving node for the first subscriber, wherein the second message indicates that the wireless device identifier for the first subscriber has changed to the second wireless device identifier.
5. A method as defined in any of statements 1-4, wherein the method further comprises:
   receiving an identifier request for the wireless device identifier for the first subscriber from a third network node; and sending the second wireless device identifier for the first subscriber to the third network node.
6. A method as defined in statement 5, wherein the third network node is an IP Multimedia Subsystem Application Server, IMS-AS.
7. A method as defined in any of statements 1-6, wherein the method further comprises:
   receiving a first subscription request from an exposure function, EF, node in the telecommunication network, wherein the first subscription request requests notification of changes to the wireless device identifier for the first subscriber; and
   after the change to the second wireless device identifier for the first subscriber, notifying the EF node of the second wireless device identifier for the first subscriber.
8. A method as defined in any of statements 1-7, wherein the first message is a deregistration message that triggers the deletion of a registration of the wireless device for the first subscriber from a mobility management node (e.g. an MME or AMF) in the second core network.
9. A method as defined in statement 8, wherein the deregistration message is a Nudm_UECM_AMFDeregistration service operation or a Nhss_UECM_MMEDeregistration service operation.
10. A method as defined in any of statements 1-7, wherein the first message is a registration update message that triggers the update of a registration of the wireless device for the first subscriber in a mobility management node in the second core network.
11. A method as defined in statement 10, wherein the registration update message is a Nudm_UECM_Update service operation or a Nhss_UECM_Update service operation.
12. A method as defined in any of statements 1-7, wherein the method further comprises:
   receiving a second subscription request from the second network node, wherein the second subscription request requests notification of changes to the wireless device identifier for the first subscriber;
   wherein the first message is sent to the second network node as a result of the second subscription request and the change of the wireless device identifier for the first subscriber to the second wireless device identifier.
13. A method as defined in any of statements 1-12, wherein the method further comprises sending a third subscription request to the second network node, wherein the third subscription request requests notification of changes to the wireless device identifier for the first subscriber.
14. A method as defined in any of statements 1-13, wherein the method further comprises:
   receiving a third message from the second network node, wherein the third message indicates a third wireless device identifier for the first subscriber; and
   storing the third wireless device identifier for the first subscriber.
15. A method as defined in statement 14 when dependent on statement 13, wherein the third message is received from the second network node as a result of the third subscription request.
16. A method as defined in any of statements 1-15, wherein each of the first wireless device identifier and the second wireless device identifier is an International Mobile Equipment Identifier, IMEI, an IMEI Software Version, SV, or a Permanent Equipment Identifier, PEI.
17. A method as defined in any of statements 1-16, wherein the first network node is a Home Subscriber Server, HSS, and the second network node is a Unified Data Management, UDM, node.
18. A method as defined in any of statements 1-17, wherein the first network node is a Unified Data Management, UDM, node and the second network node is a Home Subscriber Server, HSS.
19. A method of operating a second network node in a second core network of a telecommunication network, wherein the second network node is for managing data relating to subscribers of the second core network, wherein the telecommunication network further comprises a first core network having a first network node that is for managing data relating to subscribers of the first core network, wherein the data comprises a first wireless device identifier for a first subscriber, wherein the method comprises:
   receiving a first message from the first network node indicating a second wireless device identifier for the first subscriber; and
   storing the second wireless device identifier for the first subscriber.
20. A method as defined in statement 19, wherein the first message indicates that a wireless device identifier for the first subscriber has changed to the second wireless device identifier.
21. A method as defined in statement 19, wherein the first message indicates that the first wireless device identifier for the first subscriber has changed to the second wireless device identifier.
22. A method as defined in any of statements 19-21, wherein the method further comprises:
   receiving an identifier request for the wireless device identifier for the first subscriber from a third network node; and
   sending the second wireless device identifier for the first subscriber to the third network node.
23. A method as defined in statement 22, wherein the third network node is an IP Multimedia Subsystem Application Server, IMS-AS.
24. A method as defined in any of statements 19-23, wherein the method further comprises:
   receiving a first subscription request from an exposure function, EF, node in the telecommunication network, wherein the first subscription request requests notification of changes to the wireless device identifier for the first subscriber; and
   after the change to the second wireless device identifier for the first subscriber, notifying the EF node of the second wireless device identifier for the first subscriber.
25. A method as defined in any of statements 19-24, wherein the method further comprises:
   receiving a second message from a serving node for the first subscriber, wherein the second message indicates that the wireless device identifier for the first subscriber has changed to a third wireless device identifier.
26. A method as defined in statement 25, wherein the method further comprises:
   sending a third message to the first network node, wherein the third message indicates the third wireless device identifier for the first subscriber.
27. A method as defined in any of statements 19-26, wherein the first message is a deregistration message that triggers the deletion of a registration of the wireless device for the first subscriber from a mobility management node in the second core network.
28. A method as defined in statement 27, wherein the deregistration message is a Nudm_UECM_AMFDeregistration service operation or a Nhss_UECM_MMEDeregistration service operation.
29. A method as defined in any of statements 19-26, wherein the first message is a registration update message that triggers the update of a registration of the wireless device for the first subscriber in a mobility management node in the second core network.
30. A method as defined in statement 29, wherein the registration update message is a Nudm_UECM_Update service operation or a Nhss_UECM_Update service operation.
31. A method as defined in any of statements 19-26, wherein the method further comprises:
   prior to receiving the first message, sending a second subscription request to the first network node, wherein the second subscription request requests notification of changes to the wireless device identifier for the first subscriber.
32. A method as defined in any of statements 19-31, wherein the method further comprises receiving a third subscription request from the first network node, wherein the third subscription request requests notification of changes to the wireless device identifier for the first subscriber.
33. A method as defined in any of statements 19-32, wherein each of the first wireless device identifier and the second wireless device identifier is an International Mobile Equipment Identifier, IMEI, an IMEI Software Version, SV, or a Permanent Equipment Identifier, PEI.
34. A method as defined in any of statements 19-33, wherein the first network node is a Home Subscriber Server, HSS, and the second network node is a Unified Data Management, UDM, node.
35. A method as defined in any of statements 19-34, wherein the first network node is a Unified Data Management, UDM, node and the second network node is a Home Subscriber Server, HSS.
36. A method of operating an exposure function, EF, node in a telecommunication network, wherein the telecommunication network comprises a first core network comprising a first network node that is for managing data relating to subscribers of the first core network, and a second core network having a second network node that is for managing data relating to subscribers of the second core network, wherein the method comprises:
   sending a subscription request to only one of the first network node and the second network node, wherein the subscription request requests notification of changes to a wireless device identifier for a first subscriber of the first core network and the second core network.
37. A method as defined in statement 36, wherein the EF node does not send a subscription request to the other one of the first network node and the second network node.
38. A method as defined in statement 36 or 37, wherein the method further comprises:
   receiving, from the one of the first network node and the second network node, a notification for the first subscriber of a change from a first wireless device identifier to a second wireless device identifier.
39. A method as defined in any of statements 36-38, wherein each of the first wireless device identifier and the second wireless device identifier is an International Mobile Equipment Identifier, IMEI, an IMEI Software Version, SV, or a Permanent Equipment Identifier, PEI.
40. A method as defined in any of statements 36-39, wherein the first network node is a Home Subscriber Server, HSS, and the second network node is a Unified Data Management, UDM, node.
41. A method as defined in any of statements 36-40, wherein the first network node is a Unified Data Management, UDM, node and the second network node is a Home Subscriber Server, HSS.
42. A method of operating a first network node in a first core network of a telecommunication network, wherein the first network node is for managing data relating to subscribers of the first core network, wherein the method comprises:
   storing a first wireless device identifier for a first subscriber, and a first timestamp associated with the first wireless device identifier;
   sending a first request to a second network node in a second core network of the telecommunication network, wherein the first request requests a wireless device identifier for the first subscriber from the second network node;
   receiving a first message from the second network node indicating a second wireless device identifier for the first subscriber and a second timestamp associated with the second wireless device identifier;
   determining which of the first wireless device identifier and the second wireless device identifier has the most recent timestamp; and
   selecting a wireless device identifier for the first subscriber as the one of the first wireless device identifier and the second wireless device identifier having the most recent timestamp.
43. A method as defined in statement 42, wherein the first request is sent to the second network node in response to receiving a second request from a third network node for the wireless device identifier for the first subscriber.
44. A method as defined in statement 43, wherein the method further comprises:
   receiving the second request for the wireless device identifier for the first subscriber; and
   sending the selected one of the first wireless device identifier and the second wireless device identifier for the first subscriber to the third network node.
45. A method as defined in statement 43 or 44, wherein the third network node is an IP Multimedia Subsystem Application Server, IMS-AS.
46. A method as defined in any of statements 42-45, wherein the first network node is a Home Subscriber Server, HSS, and the second network node is a Unified Data Management, UDM, node.
47. A method as defined in statement 46, wherein the first request is a Nudm_UECM_Get service operation.
48. A method as defined in any of statements 42-45, wherein the first network node is a Unified Data Management, UDM, node and the second network node is a Home Subscriber Server, HSS.
49. A method as defined in any of statements 42-48, wherein each of the first wireless device identifier and the second wireless device identifier is an International Mobile Equipment Identifier, IMEI, an IMEI Software Version, SV, or a Permanent Equipment Identifier, PEI.
50. A method of operating a second network node in a second core network of a telecommunication network, wherein the second network node is for managing data relating to subscribers of the second core network, wherein the method comprises:
   storing a wireless device identifier for a first subscriber, and a timestamp associated with the wireless device identifier;
   receiving a first request from a first network node in a first core network of the telecommunication network, wherein the first request requests a wireless device identifier for the first subscriber from the second network node;
   sending a first message to the first network node indicating the stored wireless device identifier for the first subscriber and the timestamp associated with the stored wireless device identifier.
51. A method as defined in statement 50, wherein the first network node is a Home Subscriber Server, HSS, and the second network node is a Unified Data Management, UDM, node.
52. A method as defined in statement 51, wherein the first request is a Nudm_UECM_Get service operation.
53. A method as defined in any of statements 50-52, wherein the first network node is a Unified Data Management, UDM, node and the second network node is a Home Subscriber Server, HSS.
54. A method as defined in any of statements 50-53, wherein the wireless device identifier is an International Mobile Equipment Identifier, IMEI, an IMEI Software Version, SV, or a Permanent Equipment Identifier, PEI.
55. A computer program product comprising a computer readable medium having computer readable code embodied therein, the computer readable code being configured such that, on execution by a suitable computer or processing unit, the computer or processing unit is caused to perform the method of any of statements 1-54.
56. A first network node for use in a first core network of a telecommunication network, wherein the first network node is for managing data relating to subscribers of the first core network, wherein the telecommunication network further comprises a second core network having a second network node that is for managing data relating to subscribers of the second core network, wherein the first network node is configured to perform the method according to any of statements 1-18 or 42-49.
57. A first network node for use in a first core network of a telecommunication network, wherein the first network node is for managing data relating to subscribers of the first core network, wherein the telecommunication network further comprises a second core network having a second network node that is for managing data relating to subscribers of the second core network, wherein the first network node comprises:
   processing circuitry configured to perform any of the steps of the method according to any of statements 1-18 or 42-49; and
   power supply circuitry configured to supply power to the first network node.
58. A second network node for use in a second core network of a telecommunication network, wherein the second network node is for managing data relating to subscribers of the second core network, wherein the telecommunication network further comprises a first core network having a first network node that is for managing data relating to subscribers of the first core network, wherein the data comprises a first wireless device identifier for a first subscriber, wherein the second network node is configured to perform the method according to any of statements 19-35 or 50-54.
59. A second network node for use in a second core network of a telecommunication network, wherein the second network node is for managing data relating to subscribers of the second core network, wherein the telecommunication network further comprises a first core network having a first network node that is for managing data relating to subscribers of the first core network, wherein the data comprises a first wireless device identifier for a first subscriber, wherein the second network node comprises:
   processing circuitry configured to perform any of the steps of the method according to any of statements 19-35 or 50-54; and
   power supply circuitry configured to supply power to the second network node.
60. An exposure function, EF, node for use in a telecommunication network, wherein the telecommunication network comprises a first core network comprising a first network node that is for managing data relating to subscribers of the first core network, and a second core network having a second network node that is for managing data relating to subscribers of the second core network, wherein the EF node is configured to perform the method according to any of statements 36-41.
61. An exposure function, EF, node for use in a telecommunication network, wherein the telecommunication network comprises a first core network comprising a first network node that is for managing data relating to subscribers of the first core network, and a second core network having a second network node that is for managing data relating to subscribers of the second core network, wherein the EF node comprises:
   processing circuitry configured to perform any of the steps of the method according to any of statements 36-41; and
   power supply circuitry configured to supply power to the EF node.

1. A method of operating a first network node in a first core network of a telecommunication network, wherein the first network node is for managing data relating to subscribers of the first core network, wherein the telecommunication network further comprises a second core network having a second network node that is for managing data relating to subscribers of the second core network, wherein the method comprises:
after a first wireless device identifier for a first subscriber of the first core network and the second core network is changed to a second wireless device identifier, sending a first message to the second network node indicating the second wireless device identifier for the first subscriber.

2-36. (canceled)

37. A first network node for use in a first core network of a telecommunication network, wherein the first network node is for managing data relating to subscribers of the first core network, wherein the telecommunication network further comprises a second core network having a second network node that is for managing data relating to subscribers of the second core network, wherein the first network node is configured to:
after a first wireless device identifier for a first subscriber of the first core network and the second core network is changed to a second wireless device identifier, send a first message to the second network node indicating the second wireless device identifier for the first subscriber.

38. A first network node as defined in claim 37, wherein the first message indicates that (i) a wireless device identifier for the first subscriber has changed to the second wireless device identifier; or (ii) the first wireless device identifier for the first subscriber has changed to the second wireless device identifier.

39. A first network node as defined in claim 37, wherein the first network node is further configured to:
receive a second message from a serving node for the first subscriber, wherein the second message indicates that the wireless device identifier for the first subscriber has changed to the second wireless device identifier.

40. A first network node as defined in claim 37, wherein the first network node is further configured to:
receive an identifier request for the wireless device identifier for the first subscriber from a third network node; and
send the second wireless device identifier for the first subscriber to the third network node.

41. A first network node as defined in claim 40, wherein the third network node is an IP Multimedia Subsystem Application Server, IMS-AS.

42. A first network node as defined in claim 37, wherein the first network node is further configured to:
receive a first subscription request from an exposure function, EF, node in the telecommunication network, wherein the first subscription request requests notification of changes to the wireless device identifier for the first subscriber; and
after the change to the second wireless device identifier for the first subscriber, notify the EF node of the second wireless device identifier for the first subscriber.

43. A first network node as defined in claim 37, wherein the first message is a registration update message that triggers the update of a registration of the wireless device for the first subscriber in a mobility management node in the second core network.

44. A first network node as defined in claim 43, wherein the registration update message is a Nudm_UECM_Update service operation or a Nhss_UECM_Update service operation.

45. A first network node as defined in claim 37, wherein the first network node is further configured to:
receive a second subscription request from the second network node, wherein the second subscription request requests notification of changes to the wireless device identifier for the first subscriber;
wherein the first message is sent to the second network node as a result of the second subscription request and the change of the wireless device identifier for the first subscriber to the second wireless device identifier.

46. A first network node as defined in claim 37, wherein the first network node is further configured to send a third subscription request to the second network node, wherein the third subscription request requests notification of changes to the wireless device identifier for the first subscriber.

47. A first network node as defined in claim 37, wherein the first network node is further configured to:
receive a third message from the second network node, wherein the third message indicates a third wireless device identifier for the first subscriber; and
store the third wireless device identifier for the first subscriber.

48. (canceled)

49. A first network node as defined in claim 37, wherein each of the first wireless device identifier and the second wireless device identifier is an International Mobile Equipment Identifier, IMEI, an IMEI Software Version, SV, or a Permanent Equipment Identifier, PEI.

50. A first network node as defined in claim 37, wherein the first network node is a Home Subscriber Server, HSS, and the second network node is a Unified Data Management, UDM, node.

51. A first network node as defined in claim 37, wherein the first network node is a Unified Data Management, UDM, node and the second network node is a Home Subscriber Server, HSS.

52. A second network node for use in a second core network of a telecommunication network, wherein the second network node is for managing data relating to subscribers of the second core network, wherein the telecommunication network further comprises a first core network having a first network node that is for managing data relating to subscribers of the first core network, wherein the data comprises a first wireless device identifier for a first subscriber, wherein the second network node is configured to:
receive a first message from the first network node indicating a second wireless device identifier for the first subscriber; and
store the second wireless device identifier for the first subscriber.

53. A second network node as defined in claim 52, wherein the first message indicates that (i) a wireless device identifier for the first subscriber has changed to the second wireless device identifier; or (ii) the first wireless device identifier for the first subscriber has changed to the second wireless device identifier.

54. A second network node as defined in claim 52, wherein the second network node is further configured to:
receive an identifier request for the wireless device identifier for the first subscriber from a third network node; and
send the second wireless device identifier for the first subscriber to the third network node.

55. A second network node as defined in claim 54, wherein the third network node is an IP Multimedia Subsystem Application Server, IMS-AS.

56. A second network node as defined in claim 52, wherein the second network node is further configured to:
receive a first subscription request from an exposure function, EF, node in the telecommunication network, wherein the first subscription request requests notification of changes to the wireless device identifier for the first subscriber; and
after the change to the second wireless device identifier for the first subscriber, notify the EF node of the second wireless device identifier for the first subscriber.

57-106. (canceled)
